(19) United States
(12) Patent Application Publication
(10) Pub. No.: US 2007/0169712 A1
(43) Pub. Date: Jul. 26, 2007

(54) INVERTIBLE CAGE TO ENABLE CLEANING OF FISH-GROWING CAGES

(76) Inventors: Neil A. Sims, Kona, HI (US); Federico Rotman, Kona, HI (US)

Correspondence Address: Leighton K. Chong;Godbey Griffiths Reiss & Chong, Suite 2300, Pauahi Tower, 1001 Bishop Street, Honolulu, HI, 96813, US

(21) Appl. No.: 11/627,352

(22) Filed: Jan. 25, 2007

Related U.S. Application Data
(60) Provisional application No. 60/762,404, filed on Jan. 25, 2006.

(51) Int. Cl. A01K 61/00

(52) U.S. Cl. 119/223

(57) ABSTRACT

A fish-growing cage, of the type having a central spar or other buoyancy chamber for deploying surrounding cage netting attached thereto, has a central spar configured in an elongated shape with at least two enclosed sections at opposite ends thereof in which buoyancy is altered by changes of air and water therein so as to cause a shift of center of balance of the cage that enables the central spar with the cage netting to be rotated and inverted. The cage can be raised from its normal submerged position to an emergent position where the top half can be subject to a maintenance operation, then submerged, inverted, and raised to the emergent position again so that the bottom half can be treated. The inverting cage facilitates cleaning of the netting and air-drying, and also allows for bath-treatment, crowding harvesting, or other handling of the fish.

This U.S. patent application claims the priority filing date of U.S. Provisional Application 60/762,404 filed on Jan. 25, 2006, of the same title, by the same inventors.

### BACKGROUND OF INVENTION

Large, sea or ocean-deployed cages have been developed for growing fish in contained environments in sea or ocean waters, such as the Sea Station™ cages made by Ocean Spar, LLC, of Bainbridge Island, Wash. This type of cage typically has a central vertical spar or chamber of controllable buoyancy that is tethered at its lower end to an anchor (or anchors) or grid mooring system on the sea floor, and is used to deploy netting extending on all sides of the central spar to outer netting forming the outer boundaries for the cages.

The nets on current cages for ocean fish-growing are not able to be cleaned efficiently, and fish are not able to be crowded, bath-treated or otherwise handled efficiently. Prior techniques to clean the top half of ocean fish-growing cages include the technique of releasing the central spar from its anchor tether partially and pumping air into the central spar for buoyancy to propel it upwards toward the ocean surface so that the upper portions of the netting can be exposed for air-drying. This also may be a significant aid in controlling ectoparasites, as the air-drying of the netting also appears to kill parasite eggs that adhere to the netting. However, cleaning of the lower portions of the netting for the cage requires extensive use of divers and specialized high-pressure-washing equipment, which is very costly and time-consuming.

In addition, it is currently very difficult to crowd, bath-treat or otherwise handle fish that are contained in a Sea Station™ cage, or any other cage of the type having a central spar or other buoyancy chamber for deploying the netting. Bath-treating is a common means of controlling ectoparasites and other diseases in many fish farms. However, this is usually used when the fish are in cages that can readily be completely enveloped in a tarpaulin, and then treated with the desired chemical for a specified period of time. At the conclusion of the treatment period, the tarpaulin is dropped away to allow the chemical to dissipate in the current. Fish often also need to be crowded together for dip treating, transfer or harvest; these activities cannot be readily accomplished in a Sea Station or other cage using a central spar or other buoyancy chamber.

The design of the Sea Station™ cage has mooring bridles that reach from the anchors or grid-mooring system to attachment points on the equatorial rim of the netting. A ballast weight and anchor line are also suspended from the bottom of the spar. These attributes make it almost impossible to wrap the cage in a tarpaulin to bath-treat the fish. The only existing mechanism is to raise the cage to equatorial rim level, and attach several pie-shaped pieces of tarpaulin around the bottom half of the cage while it is in the water. This concept is very time-consuming, and can only be accomplished in low-current situations.

### SUMMARY OF INVENTION

It would therefore be desirable to provide a means of inverting a fish-growing cage of the type having a central spar or buoyancy chamber for deploying the cage netting, so that the bottom portions of the netting can be exposed to the ocean surface for cleaning or for crowding, bath-treating or otherwise handling fish contained in the lower portions of the cage.

In accordance with the present invention, a fish-growing cage of the type having a central spar or other buoyancy chamber configured in an elongated shape for deploying surrounding cage netting attached thereto comprises a buoyancy control system of dividing the central spar into at least two enclosed sections at opposite ends of the central spar and altering the buoyancy of these sections by changes of air and water therein so as to cause a shift of center of balance of the cage that enables the central spar with the cage netting to be rotated and inverted. This system can then enable cleaning of the lower portions of the cage, as well as crowding harvesting, or bath-treating of the fish. The invention method provides a means of shifting the center of balance of the spar or other buoyancy chamber. The cage is inverted by using the buoyancy of air to apply a lifting force to the lower end of the spar, while flooding an upper section to increase the weight at the top end of the spar, and to thereby provide a downward force to lower the top end of the spar. The shift in the center of gravity in the spar or other buoyancy chamber is then sufficient to invert the cage. By inverting the cage underwater, this invention also overcomes the moment arc problem for the rim by allowing the water to support the equatorial rim during inversion.

The invertible fish-growing cage thus relies upon the re-distribution of air and water ballast inside the central spar or other buoyancy chamber to change the balance equilibrium of the cage. The cage can then be raised to allow the top portions to be half-emergent, then submerged, inverted, and raised so that the bottom portions are then emergent. This therefore facilitates air-drying and also allows for bath-treatment, crowding, or other handling of the fish.

Other objects, features, and advantages of the present invention will be explained in the following detailed description of the invention having reference to the appended drawing.

### BRIEF DESCRIPTION OF DRAWINGS

FIG. 1 shows an ocean fish-growing cage having a central spar or other buoyancy chamber with sections for altering the buoyancy by air and water changes in the sections, as deployed in a normal (submerged) position.

FIG. 2 shows the cage in an emerged position.

FIG. 3 shows the cage in an inverting state.

FIG. 4 shows the cage in an inverted submerged position.

FIG. 5 shows the cage in an inverted emerged position.

### DETAILED DESCRIPTION OF INVENTION

In the following description, a preferred embodiment of the invention is described in an example using a fish-growing cage of the type having a central spar or other buoyancy chamber for deploying the netting, such as the Sea Station™ cage made by Ocean Spar, LLC, of Bainbridge Island, Wash. A person skilled in the art will realize that other embodiments of the invention are possible and that the details of the invention can be modified in a number of respects, all without departing from the inventive concept. Thus, the following description and drawings referenced herein are to be regarded as illustrative in nature and not restrictive of the invention.

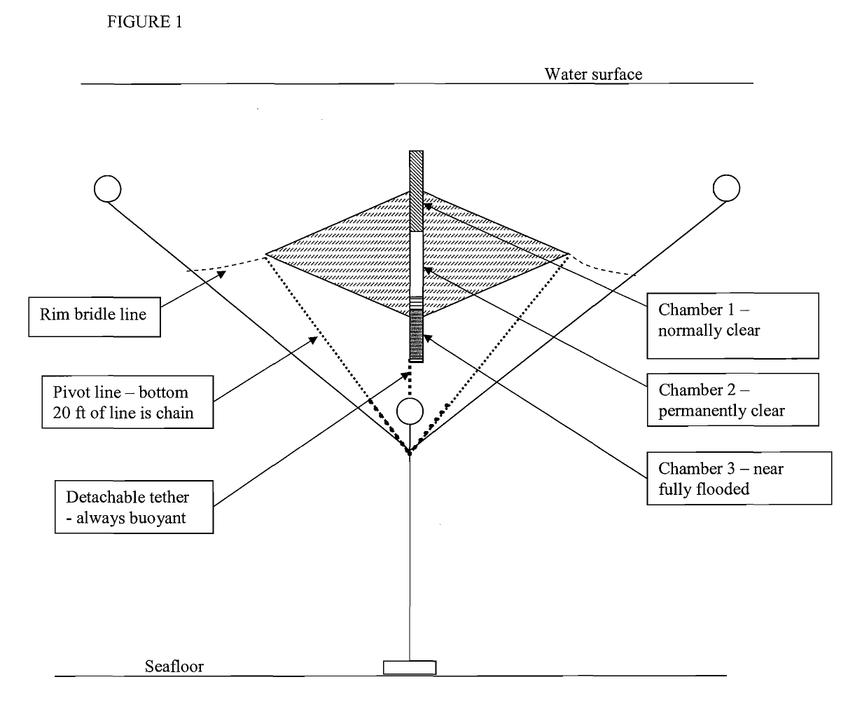

In FIG. 1, a preferred embodiment of the invention is shown in which three enclosed sections or chambers are provided inside the Sea Station™ central spar. This allows for the lower chamber to be purged by pumping or blowing compressed air or other gas into the lower chamber through a valve in the wall of the chamber (which is connected by a hose to an air compressor on a nearby vessel, or else is connected to a tank or other container filled with compressed air), and for the upper chamber to be flooded by opening a valve in the wall of the chamber to allow water to enter the upper chamber, in order to shift its center of balance and allow inverting of the cage. The center chamber is kept at partial buoyancy. Several or all of the chambers are then purged by pumping or blowing compressed air or other gas into each of the chambers through a valve to bring the cage to where it is partly-emergent. While at least two sections or chambers on opposite ends of the spar are employed to create a shift in center of balance, the number of chambers in the spar may be varied to allow more efficient or controlled inversion of the cage, or more efficient raising of the cage to the emergent position.

The number and position of valves in the spar may be varied to allow for more efficient flooding or purging of the chambers. There may be valves at each end of the spar for each chamber, to allow purging or flooding of any one chamber when the spar is inverted on either end. In one embodiment, the individual valves are not permanently connected to the air compressor or pressurized tank with hoses, but the hoses are rather connected and disconnected to the valves by divers, as required, using cam-locks, quick-connects, or other standard connectors for pressurized hose. In another embodiment, each individual valve may be permanently connected by a hose to a manifold on a nearby vessel which allows various chambers to be purged at different times without having to connect or disconnect the hoses. The embodiment shown requires a “T” valve to be located close to the hose connection into the chamber to allow a diver to vent the chamber, so that water can enter the chamber when it needs to be flooded.

The invertible Sea Station™ cage has mooring bridles attached to the equatorial rim which provide the axis for the cage to rotate. Additional stability may be provided by attaching bridle lines to a point on the ballast line (if required). For inverting the cage, the ballast line is detached from the base of the spar prior to flooding and purging the requisite chambers in the spar. The ballast line is then reattached once the cage is fully inverted. The number and position of bridle lines and ballasts and ballast lines may be varied to provide more or less mooring stability in normal situations. The sequence of steps for inverting the Sea Station cage in this example will now be described referring to the drawings.

### Cage Flip 1: Normal Position

As shown in FIG. 1, sufficient buoyancy exists in Chamber 2 to always keep the cage buoyant. This could be accomplished by making this a sealed chamber, or otherwise ensuring that it was not inadvertently flooded. Additional compressed air in Chamber 3 is applied by a hose connecting to a valve in the wall of the chamber, sufficient to lift the weight of the chains, and make the tether taut. All the loading on the cage is then on the tether—not on the rim bridles.

### Cage Flip 2: Normal Emerged

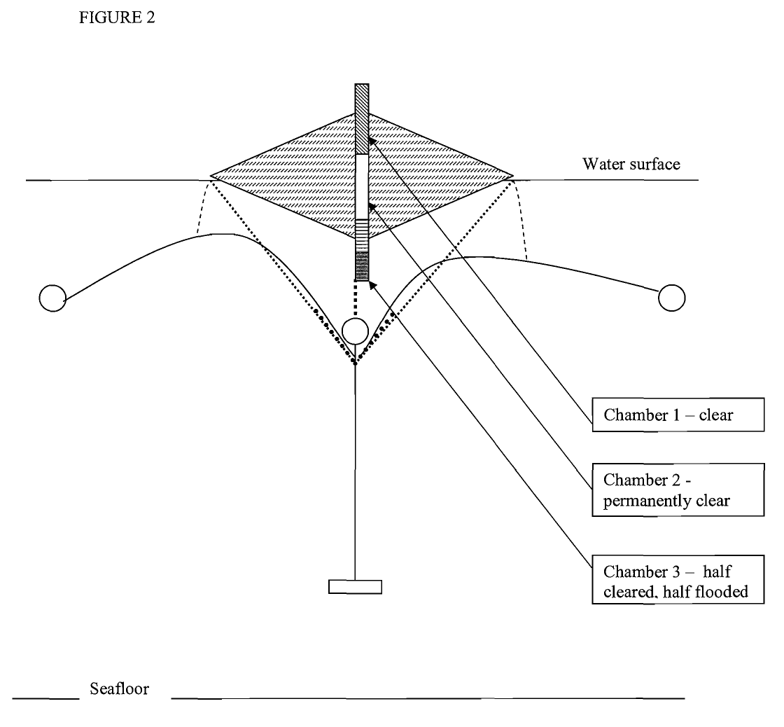

In FIG. 2, Chamber 3 is partly cleared by adding compressed air through a hose connecting to a valve in the wall of the chamber, lifting the anchor off the bottom, and raising the cage to rim level. To return the cage to submerged position, Chamber 3 is flooded by opening a valve under water, and the cage drops back into normal buoyant position, with all load on the tether.

### Cage Flip 3: Inverting

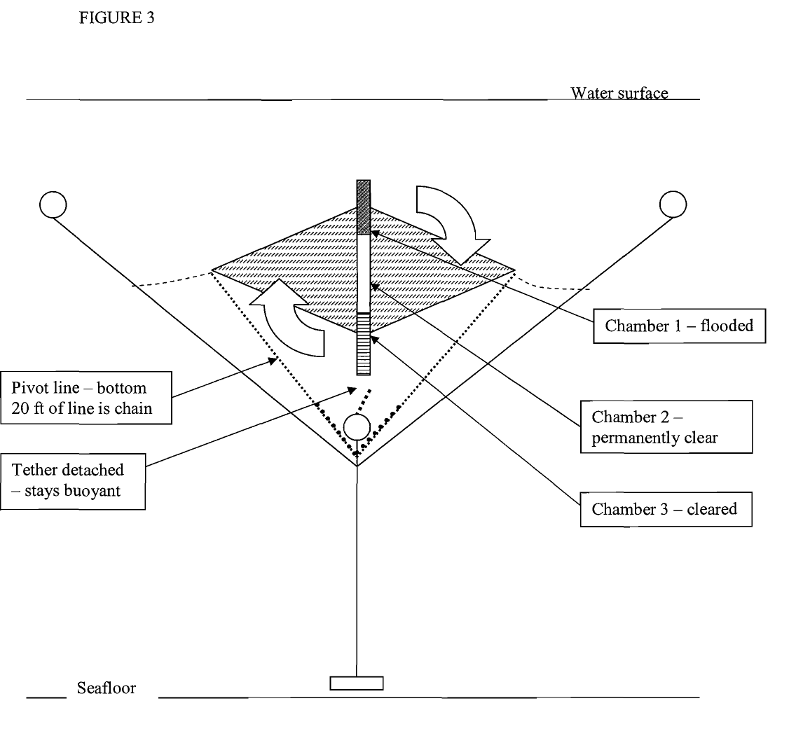

In FIG. 3, from the normal submerged position Chambers 1 and 3 are flooded by opening a valve under water, reducing cage buoyancy to 1,000 lbs or so. The weight of the chains on the bottom of the pivot line is sufficient to pull the cage down several feet so that the tether can then be detached. Chamber 3 is then cleared by adding compressed air through a hose connecting to a valve in the wall of the chamber, and the cage begins to invert. It comes to rest in Position 4 (Inverted Submerged).

### Cage Flip 4: Inverted Submerged

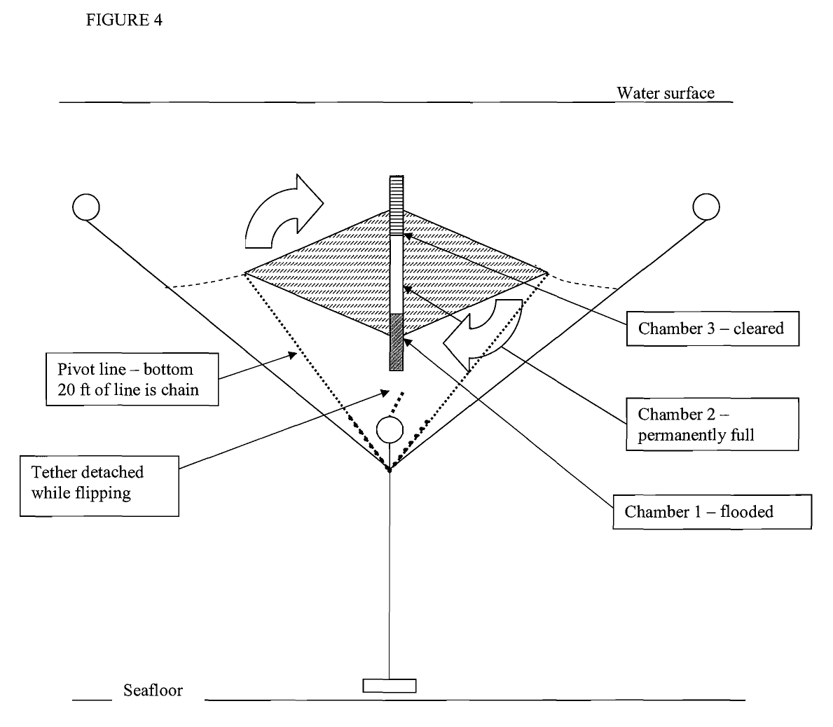

In FIG. 4, inversion is completed. The cage is still positively buoyant, but the weight of the chains on the bottom of the pivot lines is sufficient to pull the cage into negative buoyancy. The minute amount of sinking from the weight of the chains (several feet) provides the clearance needed to reattach the tether. The pivot lines are set up so that the base of the spar never moves too far away from the free-floating top of the tether. Once the tether is reattached, Chamber 1 is partially cleared (by adding compressed air through a hose connecting to a valve in the wall of the chamber), to apply all the load back onto the tether. More air is added by adding compressed air through a hose connecting to a valve to then raise the cage to Position 5 (Inverted Emerged).

### Cage Flip 5: Inverted Emerged

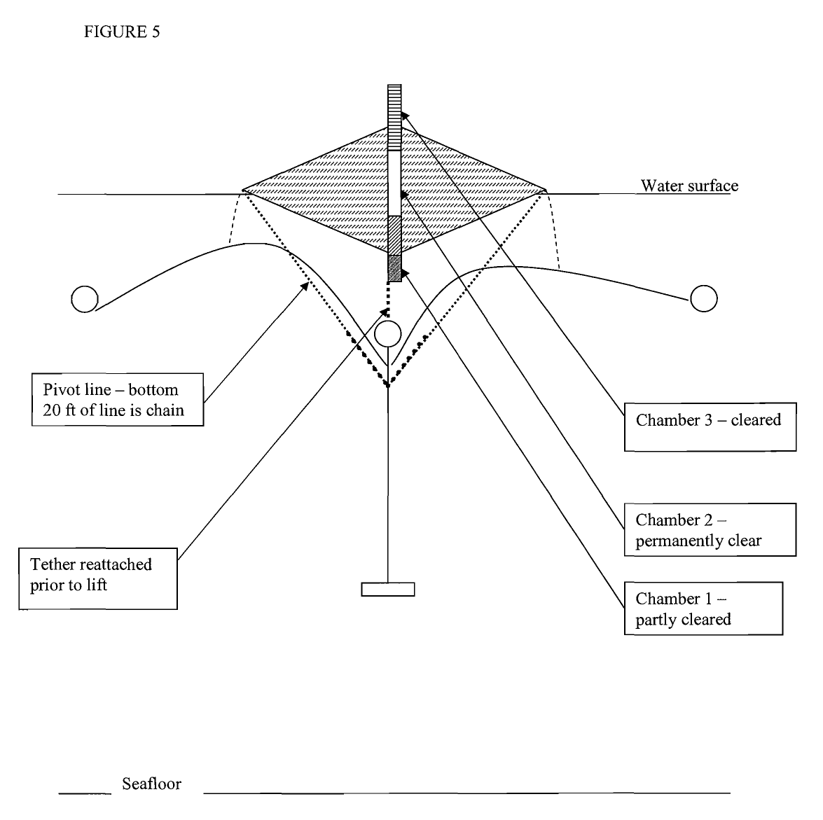

In FIG. 5, as Chamber 1 is cleared by adding compressed air through a hose connecting to a valve, the cage is raised to the surface, to rim level. It can then be submerged by opening any valve in the wall the desired chamber under water to flood any one of the chambers.

One main advantage of the invertible cage is that it allows for more efficient cleaning of cages by enabling air-drying of the top half and the bottom half of each cage in turn, and high-pressure washing of the nets while they are exposed to the air, rather than in water.

Another advantage of the invertible cage is that it allows for easier bath-treating of fish to aid in control of ectoparasites and other diseases. To effect this, the cage is lifted to where it is emergent, so that a tarpaulin or sheet of plastic or cloth material can be stretched close to the water surface, across the equator of the cage, dividing the cage in two. The cage can then be submerged, inverted, and raised again. All the fish are then contained inside the tarpaulin or sheet of plastic or cloth material, where they can be treated by administering concentrated therapeutants. Once the treatment period is over, the spar can be flooded by releasing air from the spar or other chamber through a valve, in the usual manner of lowering the cage, and thereby rapidly dissipating the bath treatment water.

Another advantage of the invertible cage is that it can be used to concentrate the fish in a smaller volume of the cage, for harvesting or other handling or management. To effect this, the cage is lifted to where it is emergent, so that a sheet of netting material or similar divider can be stretched across one section of the cage, dividing the cage in two or more. The cage can then be submerged, inverted, and raised again. All the fish are then contained on the upper side of the sheet of netting or other material, where they can be readily crowded and handled for harvesting or pumping. Once the fish harvest or handling is completed, the spar can be flooded by releasing air in the usual manner of lowering the cage, and thereby allowing the fish density to be easily reduced.

It is to be understood that many modifications and variations may be devised given the above description of the principles of the invention. It is intended that all such modifications and variations be considered as within the spirit and scope of this invention, as defined in the following claims.

1. A fish-growing cage of the type having a central spar or other buoyancy chamber for deploying surrounding cage netting attached thereto, comprising:
(a) a buoyancy control system including the central spar being configured in an elongated shape with at least two enclosed sections at opposite ends thereof;
(b) means for altering buoyancy of the at least two enclosed sections at opposite ends of the central spar by changes of air and water therein so as to cause a shift of center of balance of the cage that enables the central spar with the cage netting to be rotated and inverted.

2. A fish-growing cage according to claim 1, wherein said central spar has 3 enclosed sections, including a first section at one end thereof, a second section in the middle thereof, and a third section at an opposite end thereof from the one end, and said means for altering buoyancy comprises means for pumping air into the first section and water into the second section when the cage is in a normal position, and means for removing air and pumping in water in the first section and for removing water and pumping in air in the third section when the cage is to be inverted.

3. A fish-growing cage according to claim 2, wherein the second section is maintained with partial buoyancy to support the netting when air and water changes are being performed in the first and third sections.

4. A method of inverting a fish-growing cage of the type having a central spar or other buoyancy chamber for deploying surrounding cage netting attached thereto, comprising:
(a) providing a buoyancy control system including the central spar being configured in an elongated shape with at least two enclosed sections at opposite ends thereof;
(b) altering buoyancy of the at least two enclosed sections at opposite ends of the central spar by changes of air and water therein so as to cause a shift of center of balance of the cage that enables the central spar with the cage netting to be rotated and inverted.

5. A cage inverting method according to claim 4, wherein the step of altering buoyancy includes pumping air into one section and water into the other of said at least two sections when the cage is in a normal position, and removing air and pumping in water in the one section and removing water and pumping in air in the other section when the cage is to be inverted.

6. A cage inverting method according to claim 5, wherein said central spar has 3 enclosed sections including a center section and the two sections on opposite sides thereof, and the step of altering buoyancy includes maintaining partial buoyancy in the center section to support the netting when air and water changes are being performed in two other sections.

7. A cage management method for a fish-growing cage of the type having a central spar or other buoyancy chamber for deploying surrounding cage netting attached thereto in a sea or ocean, comprising:
(a) providing an anchor weighting system attached to a lower end of the central spar which can at times retain the central spar and attached cage netting in a submerged position below the sea or ocean surface and at other times release the central spar and attached cage netting to an emergent position wherein at least an upper part of the netting is exposed to the sea or ocean surface;
(b) providing a buoyancy control system including the central spar being configured in an elongated shape with at least two enclosed sections at opposite ends thereof;
(c) operating the anchor weighting system to retain the central spar and attached cage netting in the submerged position below the sea or ocean surface for normal operation;
(d) operating the anchor weighting system to release the central spar and attached cage netting to the emergent position exposed to the sea or ocean surface for a maintenance operation on one side of the netting;
(e) operating the anchor weighting system to retain the central spar and attached cage netting in the submerged position below the sea or ocean surface for an inversion operation;
(f) altering buoyancy of the at least two enclosed sections at opposite ends of the central spar by changes of air and water therein so as to cause a shift of center of balance of the cage that enables the central spar with the cage netting to be rotated and inverted while in the submerged position; and
(g) operating the anchor weighting system to release the central spar and attached cage netting to the emergent position exposed to the sea or ocean surface for a maintenance operation on the other side of the netting.

8. A cage management method according to claim 7, wherein the management operation is for cleaning top and bottom sides of the netting.

9. A cage management method according to claim 8, wherein the cleaning operation includes air drying the top and bottom sides of the netting in turns.

10. A cage management method according to claim 7, wherein the management operation is one of the group consisting of crowding, harvesting, and bath-treating of the fish.

11. A cage management method according to claim 10 for bath-treating of fish to aid in control of ectoparasites and other diseases by releasing the cage to the emergent position, stretching a tarpaulin or sheet material close to the water surface across an equator rim of the cage so as to cover one half thereof, then retaining the cage to the submerged position, inverting it, releasing the cage to the emergent position again, and stretching a tarpaulin or sheet material across the equator rim of the cage so as to cover the other half thereof, whereby the fish therein are contained inside the tarpaulin or sheet material where they can be treated by administering concentrated therapeutants.

12. A cage management method according to claim 10 for concentrating the fish in a smaller volume of the cage for harvesting or other handling or management by releasing the cage to the emergent position, stretching a sheet of netting material or similar divider across one section of the cage dividing the cage in two or more sections, then retaining the cage to the submerged position, inverting it, and releasing the cage to the emergent position again, wherein all the fish therein are contained on an upper side of the sheet of netting material where they can be readily crowded and handled for harvesting or pumping.
